(19) United States
(12) Patent Application Publication
(10) Pub. No.: US 2024/0065299 A1
(43) Pub. Date: Feb. 29, 2024

(54) BEVERAGE ADDITIVES AND DELIVERY SYSTEMS

(71) Applicant: Cirkul, Inc., Tampa, FL (US)

(72) Inventors: Garrett Waggoner, Tampa, FL (US); Andrew Gay, Apollo Beach, FL (US)

(73) Assignee: Cirkul, Inc., Tampa, FL (US)

(21) Appl. No.: 18/458,753

(22) Filed: Aug. 30, 2023

Related U.S. Application Data
(60) Provisional application No. 63/402,694, filed on Aug. 31, 2022.

(51) Int. Cl. A23L 2/68; A23L 2/60

(52) U.S. Cl. CPC A23L 2/68; A23L 2/60

(57) ABSTRACT

Beverage additives and additive delivery systems including an additive with relatively low pH, specific gravity and/or viscosity can aid in mixing with a base liquid or other flow performance while producing a suitably tart or otherwise flavored beverage are disclosed. Methods of mixing and forming a beverage including water, an additive, an acidulant and a flavor system are disclosed.

### RELATED APPLICATIONS

This application claims the benefit under 35 USC § 119 to U.S. Provisional Application No. 63/402,694, filed Aug. 31, 2022, which is hereby incorporated by reference in its entirety.

### FIELD

Disclosed embodiments are related to beverage additives.

### BACKGROUND

Beverage additives are used to provide flavor or nutritive properties to beverages.

### SUMMARY

Beverage additives and additive delivery systems as described herein and/or set forth in the claims below.

In some embodiments, a beverage additive comprises: water at a proportion of about 40% to about 85% by weight of the additive; an acidulant at a total proportion of about 1% to about 20% by weight of the additive, the acidulant comprising phosphoric acid at a proportion of about 0.1% to about 2% by weight of the additive; and a flavor system at a proportion of about 10% to about 40% by weight of the additive.

In some embodiments, a beverage additive for use in an additive delivery system comprises: water at a proportion of about 40% to about 85% by weight of the additive; an acidulant at a proportion of about 1% to about 20% by weight of the additive; and a flavor system at a proportion of about 10% to about 40% by weight of the additive. In some cases, the beverage additive can have a viscosity and/or a specific gravity selected to facilitate mixing of the beverage additive with a base fluid within a mixing space of the additive delivery system. The mixing space in some embodiments may fluidly couple an additive reservoir and a base fluid container to a delivery system outlet. The additive delivery system can be configured to dispense the beverage additive from the additive reservoir and dispense the base fluid from the base fluid container into the mixing space in response to a user drawing fluid through the delivery system outlet.

In some embodiments, a beverage additive for use in an additive delivery system comprises: water at a proportion of about 40% to about 85% by weight of the additive; an acidulant at a proportion of about 1% to about 20% by weight of the additive; and a flavor system at a proportion of about 10% to about 40% by weight of the additive, wherein the beverage additive has a kinematic viscosity between about 3 square millimeters per second (mm²/s) and about 7 mm²/s.

In some embodiments, a beverage additive for use in an additive delivery system comprises: water at a proportion of about 40% to about 85% by weight of the additive; an acidulant at a proportion of about 1% to about 20% by weight of the additive; and a flavor system at a proportion of about 10% to about 40% by weight of the additive, wherein the beverage additive has a specific gravity of about 0.9 to about 1.3.

In some even further embodiments still, a beverage additive for use in an additive delivery system comprises: water at a proportion of about 40% to about 85% by weight of the additive; an acidulant at a proportion of about 1% to about 20% by weight of the additive, the acidulant comprising: citric acid at a proportion of about 0.1% to about 10% by weight of the additive, lactic acid at a proportion of about 0.1% to about 10% by weight of the additive, and/or phosphoric acid at a proportion of about 0.1% to about 2% by weight of the additive; and a flavor system at a proportion of about 10% to about 40% by weight of the additive.

In some embodiments, an additive delivery system comprises: an additive reservoir; a beverage additive contained within the additive reservoir, the additive comprising: water at a proportion of about 40% to about 85% by weight of the additive, an acidulant at a proportion of about 1% to about 20% by weight of the additive, a flavor system at a proportion of about 10% to about 40% by weight of the additive, and the additive having at least one of: a kinematic viscosity between about 3 square millimeters per second (mm²/s) and about 7 mm²/s, and a specific gravity between about 0.9 and about 1.3. The system may include a base fluid container; a delivery system outlet; and/or a mixing nozzle fluidly coupling the additive reservoir and the base fluid container to the delivery system outlet. The additive delivery system may be configured to dispense the beverage additive from the additive reservoir and dispense the base fluid from the base fluid container into the mixing nozzle in response to a user drawing fluid through the delivery system outlet.

In some embodiments, a method of mixing a beverage comprises: passing a beverage additive from an additive reservoir of an additive delivery system to a mixing space of the additive delivery system, the additive comprising: water at a proportion of about 40% to about 85% by weight of the additive, an acidulant at a proportion of about 1% to about 20% by weight of the additive, a flavor system at a proportion of about 10% to about 40% by weight of the additive, and the additive having at least one selected from the group consisting of: a kinematic viscosity between about 3 square millimeters per second (mm²/s) and about 7 mm²/s, and a specific gravity between about 0.9 and about 1.3; passing a base fluid from a base fluid container of the additive delivery system to the mixing nozzle; mixing the additive and the base fluid together in the mixing space to form a beverage; and passing the beverage from the mixing space to a delivery system outlet.

In some embodiments, a method of mixing a beverage comprises: passing a beverage additive from an additive reservoir of an additive delivery system to a mixing nozzle of the additive delivery system, the additive comprising: water at a proportion of about 40% to about 85% by weight of the additive, an acidulant at a proportion of about 1% to about 20% by weight of the additive, the acidulant comprising: citric acid at a proportion of about 0.1% to about 10% by weight of the additive, lactic acid at a proportion of about 0.1% to about 10% by weight of the additive, and phosphoric acid at a proportion of about 0.1% to about 2% by weight of the additive, and a flavor system at a proportion of about 10% to about 40% by weight of the additive; passing a base fluid from a base fluid container of the additive delivery system to the mixing nozzle; mixing the additive and the base fluid together in the mixing nozzle to form a beverage within a mixing space of the additive delivery system; and passing the beverage from the mixing nozzle to a delivery system outlet.

In some embodiments, a method of forming a beverage additive comprises: providing water at a proportion of about 40% to about 85% by weight of the additive; providing a flavor system at a proportion of about 10% to about 40% by weight of the additive; providing citric acid at a proportion of about 0.1% to about 10% by weight of the additive; providing lactic acid at a proportion of about 0.1% to about 10% by weight of the additive; providing phosphoric acid at a proportion of about 0.1% to about 2% by weight of the additive, the proportion of phosphoric acid being sufficient to maintain: a total proportion of acid between about 1% and about 20% by weight of the additive, a pH of the additive between about 2.0 and about 3.3, and at least one of: a specific gravity of the additive between about 0.9 and 1.3, and a kinematic viscosity of the additive between about 3 square millimeters per second (mm²/s) and about 7 mm²/s; and mixing the water, the flavor system, the citric acid, the lactic acid, and the phosphoric acid to form the beverage additive.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is an exploded perspective view of one embodiment of an additive delivery system;

FIG. 2 is an exploded perspective view of one embodiment of a cartridge assembly of the additive delivery system of FIG. 1;

FIG. 3 is a perspective view of an additive reservoir of the cartridge assembly of FIG. 2;

FIG. 4 is a top view of the additive reservoir of FIG. 3; and

FIG. 5 is a cutaway view of one embodiment of an additive delivery system.

### DETAILED DESCRIPTION

Beverage additives may be added to or mixed in with a beverage or other base fluid to modify and/or introduce characteristics to the base fluid. For example, some additives may modify a flavor or introduce a flavor to a beverage or a base fluid. Other additives may modify a nutritive property or introduce a new nutritive property, for example using vitamins, minerals, or other nutrients. Some additives may modify a stimulating effect or introduce a stimulating effect to the beverage, for example using a stimulant such as caffeine or another compound such as taurine.

Beverage additives may be used in conjunction with additive delivery systems such as those configured to mix an additive with a base fluid such as water. Some additive delivery systems, referred to here as “point-of-use” systems, may hold a volume of additive and a volume of base fluid in separate containers or reservoirs and may be configured to mix the additive and base fluid immediately prior to consumption or other dispensing of the mixture. Some point-of-use systems, referred to here as “flow-through” systems, may be configured to perform this mixing within one or more flow paths coupled between the volume of base fluid and/or the volume of additive and a dispensing outlet of the system. Mixing of the additive and base fluid can be performed without introducing the additive to the volume of base fluid or introducing the base fluid to the volume of additive. Rather, the additive and base fluid can be provided from their respective container or reservoir, mixed together and dispensed.

Some point-of-use or flow-through systems may store additive and the base fluid in separate containers or reservoirs until a user dispenses fluid from (e.g., drinks, pours, draws, squeezes, or otherwise dispenses from) the system. For example, some flow-through systems may be configured to dispense an additive from an additive reservoir and base fluid from a base fluid container along a flow path in response to a user dispensing fluid from the system. Additionally, or alternatively, some point-of-use or flow-through systems may include a metering mechanism or other arrangement configured to allow a user to control a proportion of additive and/or base fluid that is mixed together. For example, a flow-through system may include an adjustable metering space which may be adjusted in size or other property to increase or decrease a flow rate of the additive through the system. Additionally, or alternatively, some point-of-use or flow-through systems may include mechanisms, flow paths, or other arrangements configured to facilitate, enhance, or otherwise control the mixing of the additive and the base fluid. For example, some flow-through systems may include a mixing section or a mixing space along a flow path that may be configured to improve a homogeneity or to increase a mixing rate of a beverage mixture.

Performance of an additive delivery system as described herein, including a point-of-use or flow-through systems, may be improved in various ways when used in conjunction with a beverage additive according to the present disclosure. In some embodiments, a viscosity, a density, a specific gravity, and/or other characteristic of an additive may be configured to facilitate or otherwise improve various processes within an additive delivery system, including dispensing of the additive from an additive reservoir of the system, metering of the additive from the additive reservoir, and/or mixing of the additive with the base fluid.

For example, a first additive having a lower viscosity, a lower density, or a lower specific gravity than a second additive may dispense more quickly, e.g., at a higher flow rate, from an additive reservoir or may begin dispensing more easily, e.g., may begin flowing in response to smaller forces that induce the flow, than the second additive in response to a user drawing fluid from an additive delivery system. In other examples, the first additive may flow at a different flow rate or flow through a smaller minimum metering space or have a flow rate that is more sensitive or responsive to changes in the metering space than the second additive. In still further examples, the first additive may mix with a base fluid more quickly than the second additive, e.g., resulting in a more homogeneous beverage mixture being delivered from the system. One or more of these characteristics of the first additive may be present, all while providing a similar flavoring or other modification of base fluid characteristics as the second additive. Thus, for example, a same or similar tasting beverage can be dispensed from the additive delivery system using the first additive as that using the second additive, but while providing the improved flow rate, metering, mixing or other features of the first additive.

As will be appreciated, some additive delivery systems may be required to mix the additive and the base fluid in a very short time and/or within a very small space or length of a mixing flow path. This may be particularly true in the case of some point-of-use or flow-through systems which may be configured to deliver a beverage mixture on demand from a system that can approximate the size, weight, and/or portability of a typical bottle or other drinking vessel. Achieving a desired concentration, mixture homogeneity, or other characteristic in a beverage mixture delivered from additive delivery systems may therefore require significant optimization of various parameters given the time and space constraints present in some such systems, and additives according to this disclosure can aid in such optimization.

In view of the above, the inventors have recognized that a concentration of a beverage mixture, a homogeneity of a beverage mixture, a mixing rate of an additive and a base fluid, or other mixing or metering performance qualities of an additive delivery system may be influenced by one or more properties of the additive. For example, one or more properties of an additive may be selected to optimize a mixing and/or metering performance of the additive within a system having a known design. Accordingly, the inventors have recognized and appreciated the benefits of tailoring one or more properties of an additive to optimize a mixing or metering performance of the additive within a particular additive delivery system (including a point-of-use or flow-through system, or a component thereof such as a mixing segment, a mixing nozzle, a metering segment, a metering space, an outlet, or other component).

For example, the inventors have recognized and appreciated the benefits of a beverage additive having at least one property configured to improve mixing and/or metering in an additive delivery system. In some embodiments, a viscosity, a density, and/or a specific gravity may be configured to improve a mixing and/or metering performance of an additive in an additive delivery system. For example, in some embodiments, a viscosity, a density, and/or a specific gravity may be configured (e.g., to have a relatively low value) to increase a mixing rate in an additive delivery system, to improve a homogeneity of beverage mixture delivered from an additive delivery system, to increase a dispensing rate of the additive from an additive reservoir, or to increase a metering precision of the additive in an additive delivery system. For example, an additive having a low kinematic viscosity below 7 mm²/s and/or specific gravity near 1 has been found to provide improved mixing, metering adjustment and flow in a point-of-use system.

Further to the above, the inventors have recognized that the components, subcomponents, or ingredients used in a beverage additive may influence the properties of the additive. For example, in various embodiments, an additive may include any of: a water component; an acidulant component comprising one or more acids; a flavoring component comprising one or more flavoring agents; a salt or buffer component comprising one or more salts or buffering agents; a stimulating component comprising one or more stimulants such as caffeine or taurine; and/or any other suitable component. (For example, in some embodiments preservatives may or may not be added in order to prevent microbiological growth in the additive and/or in a mixing chamber or other flow path including additive and/or base liquid such as water.) In some embodiments, a beverage additive includes at least water, acidulant and flavoring components. The inventors have recognized that the various components or subcomponents may be adjusted to produce a desired property in the beverage additive. For example, in embodiments when it may be desirable to produce an additive having a relatively low pH and specific gravity close to 1, a proportion of water and acidulant, along with the type of acidulant used, may be configured to provide the additive with the low pH and specific gravity close to 1.

Further, the inventors have recognized that various alternative subcomponents may be utilized to achieve a desired property or combination of properties in a beverage additive. For example, it may be desirable to produce a water-based beverage additive having both a pH of about 3 (e.g., for flavoring purposes) and a specific gravity of about 1 (e.g., to improve mixing and/or metering performance in an additive delivery system). It will be appreciated that the desired pH of about 3 may require a substantial acidulant component, but that the relatively high densities of many acids may increase the specific gravity significantly above the desired range. The inventors have recognized that in some such cases, it may be beneficial to configure one or more subcomponents of the acidulant component (or another component) to achieve both the desired pH and the desired specific gravity. In the non-limiting example above, a particular acid subcomponent may be used to reduce a total volume or mass of acid required to reduce the pH to the desired range, thereby reducing the effect of the acidulant component on the additive's specific gravity. For example, in some embodiments, a phosphoric acid subcomponent may be used in the acidulant component to reduce the total mass of acid required to achieve the desired pH of about 3, thereby allowing the specific gravity to remain closer to 1, which may improve a mixing and/or metering performance of the additive in an additive delivery system.

In some embodiments, because phosphoric acid may disrupt a desired flavor profile of the additive, the acidulant component may comprise one or more further acids in addition to the phosphoric acid. For example, various embodiments may comprise one or more of citric acid, lactic acid, malic acid, tartaric acid, or others, along with phosphoric acid to provide a desired taste profile, pH and density of the additive.

In some embodiments, a beverage additive may comprise water at a proportion of about 40% to about 95% by weight of the additive (e.g., about 45% to about 75% by weight); an acidulant at about 1% to about 20% by weight of the additive (e.g., about 6% to about 15% by weight); and a flavor system at a proportion of about 0.5% to about 50% by weight of the additive (e.g., about 10% to about 40%, or about 12% to about 35%). In some embodiments, the additive may have at least one property selected to facilitate dispensing, metering, and/or mixing with a base fluid in an additive delivery system. For example, in some embodiments, the additive may have a kinematic viscosity between about 1 square millimeter per second (mm²/s) to about 10 mm²/s, e.g., about 3 mm²/s to about 7 mm²/s. Additionally or alternatively, in some embodiments, the additive may have a specific gravity between about 0.9 and 1.3 (the specific gravity being taken, in some embodiments, with reference to water). Additionally or alternatively, in some embodiments, the additive may have a density between about 0.85 grams per cubic centimeter (g/cm³) and about 1.3 g/cm³.

In some embodiments, the acidulant may comprise one or more of the following, including any combination of the following: phosphoric acid at a proportion of about 0.1% to about 2% by weight of the additive; citric acid at a proportion of about 1% to about 10% by weight of the additive; and/or lactic acid at a proportion of about 1% to about 10% by weight of the additive. The acidulant may be configured to provide the additive with a desired pH (as well as other properties) of about 2 to 3.5, of about 2.3 to 3.2, of about 2.4 to 3, of about 2.6 to 3, or other. In some cases, the acidulant can comprise about 6% to about 15% by weight of the additive, with phosphoric acid comprising about 0.6% to about 1.3% by weight of the additive and a remainder of the acidulant including citric acid (at about 3.5% to about 8.5% by weight) and lactic acid (at about 2% to about 8% by weight). Such additives may have a specific gravity of about 0.95 to about 1.24 and a kinematic viscosity of about 3 mm2/s and 7 mm2/s.

In some embodiments, a flavor system may comprise a sweetener and/or at least one raw flavor. The sweetener may comprise one or more natural sweetener, such as fructose, glucose, sucrose, or others; one or more artificial sweetener, such as sucralose, aspartame, saccharin, stevia (including any combination of steviol glycosides such as stevioside, rebaudioside A, rebaudioside D, and/or any other appropriate steviol glycoside); and/or one or more sugar alcohol, such as erythritol, sorbitol, mannitol, xylitol, or others. A raw flavor may comprise one or more natural flavor (e.g., an essential oil, oleoresin, essence or extractive, protein hydrolysate, distillate, or any product of roasting, heating or enzymolysis, which contains the flavoring constituents derived from a spice, fruit or fruit juice, vegetable or vegetable juice, edible yeast, herb, bark, bud, root, leaf or similar plant material, meat, seafood, poultry, eggs, dairy products, or fermentation products thereof, whose significant function in food is flavoring rather than nutritional), and/or one or more artificial flavor (e.g., one or more substance, the function of which is to impart flavor, which is not derived from a spice, fruit or fruit juice, vegetable or vegetable juice, edible yeast, herb, bark, bud, root, leaf or similar plant material, meat, fish, poultry, eggs, dairy products, or fermentation products thereof).

In some embodiments, an additive may further comprise a buffer such as a salt buffer or other buffering agent to maintain a desired acidity or pH level. For example, in some embodiments, a salt buffer may comprise sodium citrate dihydrate, monopotassium phosphate, potassium bicarbonate, potassium citrate monohydrate, sodium chloride, or any other appropriate buffer salt or buffing agent. In some embodiments, the additive may comprise a salt buffer at a proportion of about 0.5% to about 10% by weight of the additive.

Some additive delivery systems may include certain structural or functional features which may be particularly well-suited for use with a beverage additive according to the present disclosure (although it will be appreciated that these features are discussed for the purpose of illustrating and appreciating the benefits of the additives disclosed herein, and that these benefits may also be appreciated in conjunction with any other appropriate structure or system). Some of these features will now be described, along with the beneficial interactions between the features and the fluid properties achieved by the teachings of the present disclosure.

In some embodiments, a flow-through system may comprise a base fluid container such as a bottle, a cup, or another drinking vessel, as well as an additive reservoir or volume of additive which may be attachable to or at least partially positioned within the base fluid container. In one example, a system may include an additive reservoir or a volume of additive associated with a straw or other conduit which may be dipped into a container of base fluid. In this example, the additive may be dispensed into an internal flow path defined within the straw in response to a user taking a sip of fluid through the straw. The additive may be mixed with the base fluid within the internal flow path, and a beverage mixture may be delivered through an open end of the straw.

In another example, an additive delivery system may include a cartridge system that can define or be supported by a container lid of the base fluid container. In some such embodiments, the base fluid container may be a bottle, and a container lid or bottle top may be attachable to the bottle. The cartridge system may include an additive reservoir assembly, and may be attachable to the bottle top. In this example, the additive may be dispensed from the additive reservoir assembly in response to a user taking a sip or otherwise dispensing fluid from the bottle through an outlet of the cartridge system. The additive may be mixed with the base fluid within a flow path defined by the cartridge system, and a beverage mixture may be delivered through the outlet of the cartridge system.

In some such embodiments, the cartridge system may provide one or more flow paths or flow geometries that may enhance mixing of the additive and the base fluid as the additive and base fluid flow through the cartridge system. Such flow geometries may, for example, include one or more convergence zone or mixing space where the additive and the base fluid may be mixed. Such flow geometries may also be used in conjunction with one or more agitating or turbulence-creating elements incorporated into a mixing space or another portion of the cartridge assembly to further enhance the mixing of the additive and the base fluid prior to use or consumption. Such flow geometries and agitating or turbulence-creating elements may improve a mixing performance of an additive delivery system by providing for faster or more thorough mixing of additive and base fluid.

The inventors have appreciated that the degree to which such flow geometries, (e.g., mixing spaces, agitating elements, turbulence-creating elements) are able to improve a mixing performance may be influenced by one or more properties of an additive. For example, mixing performance may be related to turbulence induced by a turbulence-creating element within a flow arrangement. The turbulence may be related to the Reynold's Number of the arrangement, and the Reynold's Number may in turn may be related to at least a density and/or a viscosity of the fluid in the arrangement. Therefore, the mixing performance resulting from a particular flow geometry may be related to at least a density and/or a viscosity of an additive in the arrangement.

In some embodiments, a cartridge system may include an additive reservoir assembly comprising a flexible additive reservoir such as a pouch, bag, bladder or similar compliant structure. In some embodiments, a flexible additive reservoir may provide improved flow, metering, and/or mixing performance by allowing a volume of additive to be dispensed therefrom without needing to replace the dispensed volume with a volume of air. This may allow for a smoother, more uniform, and/or more consistent dispensing of additive from the reservoir. In some such embodiments, a pressure may be applied to the flexible additive reservoir when a user squeezes, pours from, sips from, or otherwise dispenses fluid from the system or a container in which the cartridge is housed (e.g., a bottle).

The inventors have appreciated that a degree to which such a flexible reservoir is able to facilitate dispensing of the additive may be influenced by one or more properties of the additive. In one non-limiting example, a first additive having a first viscosity may be disposed in a first flexible reservoir, and a second additive having a second viscosity lower than the first viscosity may be disposed in a second flexible reservoir which is identical to the first flexible reservoir. In this example, if equal external pressure is applied to both the first and second flexible reservoirs, the first additive having the higher viscosity may be less responsive to the pressure than the second additive. As a result of its lower viscosity, the second additive may be dispensed faster than the first additive. It will be appreciated that similar examples may be envisioned using differences in various properties, including density, specific gravity, or others, as viscosity is not the only property which the inventors have recognized as affecting an additive's flow from a flexible reservoir.

In some embodiments, a cartridge system may provide for adjustable flow of additive from an additive reservoir. In some embodiments, an adjustment actuator may be movable by a user to adjust a size of a metering space within the cartridge system. Adjustment of the metering space may correspondingly increase or decrease the flow of additive that occurs when fluid is dispensed through the cartridge. This feature may permit a user to achieve a desired and repeatable ratio of additive to base fluid within a beverage mixture. The inventors have appreciated that a precision or effectiveness of control of the additive flow arrangement may be influenced by one or more properties of the additive. For example, an adjustable flow arrangement may achieve a more precise control or metering of a first additive having a lower viscosity or density than a second additive having a higher viscosity or density.

Although the adjustable flow arrangement, the flexible additive reservoir, and the flow geometries described above have been described in conjunction with a cartridge system, it will be appreciated that these structural and functional features may be utilized in conjunction with any suitable additive delivery system, including any appropriate point-of-use or flow-through system. Additionally, it will be appreciated that these features represent examples of structural and functional features which may have beneficial interactions with the beverage additives of the present disclosure, and that a beverage additive of the present disclosure may have beneficial interactions with any other appropriate structural or functional feature of any appropriate additive delivery system, including any appropriate point-of-use or flow-through system.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

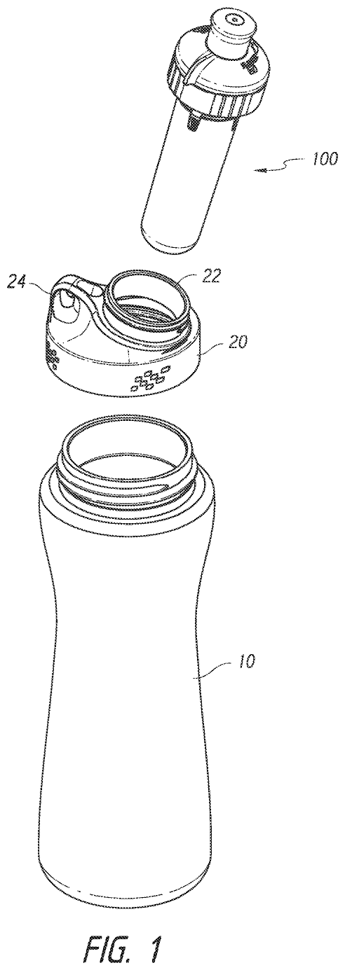

FIG. 1 is an exploded perspective view of a flow-through system provided as an example of one additive delivery system which may be used in conjunction with beverage additives according to the present disclosure. In some embodiments, beverage additives described herein have been found to be particularly effective when used with the Cirkul additive delivery system, e.g., as currently available at www.drinkcirkul.com (hereafter Cirkul products). Accordingly, some inventive embodiments include any of the beverage additives described herein in combination with additive delivery systems such as the Cirkul products. Such inventive embodiments can include the specific additive delivery components as well as the specific component sizes and/or shapes, flow path lengths, and any other selected details of the Cirkul products. It will be appreciated that although one specific embodiment of an additive delivery system is shown and described below, the beverage additives according to the present disclosure may be used in conjunction with many other additive delivery systems, including various point-of-use systems, flow-through systems, and other additive delivery systems, as the disclosure is not limited in this regard.

In the embodiment shown, a bottle 10 may include a bottle top 20 for sealing an interior space of the bottle 10. Threads, which may be integrally formed on the bottle 10 may cooperate with internal threads formed on the bottle top 20 to provide sealed fastening between the bottle 10 and the bottle top 20. A handle 24 may be formed on the bottle top 20, and an umbrella check valve or vent (not shown in FIG. 1) may be provided in the bottle top 20 in a known manner to reduce or eliminate vacuum in the bottle interior and to prevent base fluid from leaking out of the vent when a base fluid or beverage mixture is dispensed. In some embodiments, the bottle top 20 may include a cartridge-receiving mouth 22 having a threaded fastener formed on an exterior surface thereof for receiving a cartridge assembly 100. In some embodiments, the cartridge assembly 100 can engage directly with the bottle 20, e.g., via a threaded engagement, and no top 20 need be used.

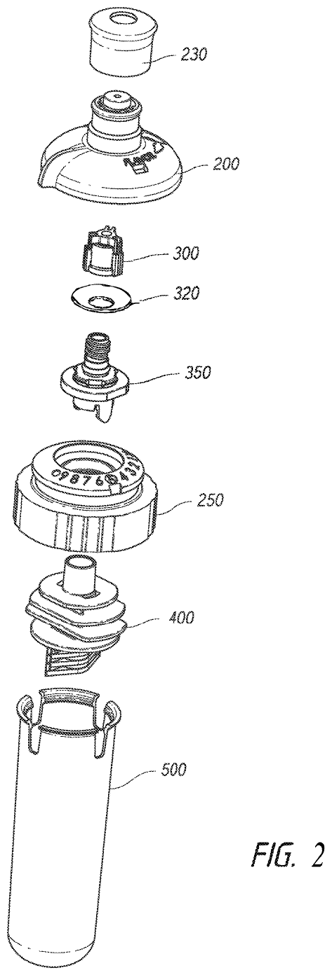

FIG. 2 depicts an exploded view of one embodiment of a cartridge assembly of a flow-through system for use with beverage additives according to the present disclosure. In some embodiments, the cartridge assembly 100 may include a number of components assembled in a generally stacked arrangement using snap-fit, press-fit, threaded connections, or similar known joining mechanisms. The components may include a cartridge cap, which in some embodiments may comprise an additive flow adjustment actuator 200 cooperating with and mounted for limited rotational movement relative to a cartridge cap base 250. The additive flow adjustment actuator 200 may include a push-pull closure 230 having a dispensing spout, the push-pull closure 230 being mounted on the additive flow adjustment actuator 200 for selectively permitting and preventing egress of fluid from the cartridge. In some embodiments, an additive flow metering component or metering insert 300 and a mixing nozzle 350 may be disposed between the additive flow adjustment actuator 200 and the cartridge cap base 250. In some embodiments, the metering insert 300 and the mixing nozzle 350 may cooperate to control a flow rate of additive through the cartridge assembly as will be described further below. In some embodiments, an annular one-way base fluid flow sealing element 320 may be included to provide for one-way flow of base fluid through the cartridge, preventing backflow of the base fluid and/or the beverage mixture.

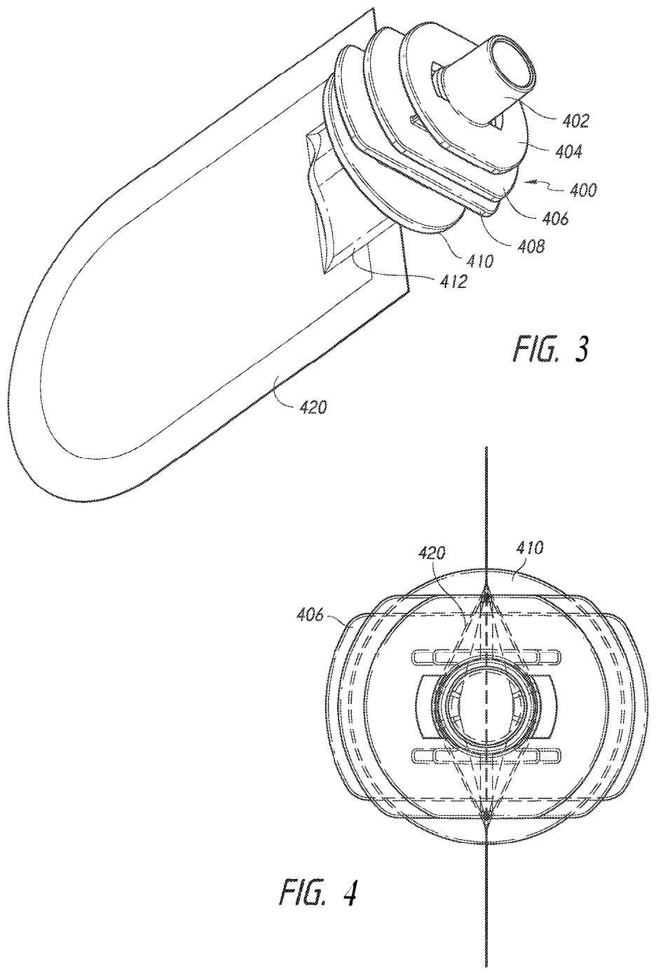

In some embodiments, a cartridge assembly may include a reservoir assembly in which a reservoir spout 400, an additive reservoir (e.g., see FIG. 3), and protective outer housing 500, may be secured to the mixing nozzle 350, and thus to the cap base 250. In some embodiments, the reservoir assembly may be secured using snap fittings or other fastening elements, such as threaded fasteners or friction fastening, within the cartridge cap base 250. In some embodiments, the reservoir assembly may be fit to the mixing nozzle 350. In some embodiments, the reservoir protective housing 500, which may be formed as a cage, a solid-walled cover, or any other appropriate geometry, may be snap-fit to a flange of the pouch reservoir spout 400 to protect the additive reservoir or flexible pouch.

FIGS. 3-4 illustrate details of an additive reservoir and a reservoir spout for use with beverage additives according to the present disclosure. In some embodiments, a spout 400 may include a stem portion 402 defining an interior additive flow passage. A first flange 404 may be provided with slots for receiving the reservoir retaining arms 374 of the mixing nozzle 300. A snap fit ridge or ring may be formed on a lower portion of the stem 402 and may cooperate with an internal ridge on a lower portion of the mixing nozzle 350. In some embodiments and as shown, a second flange 406 and a third flange 408 may extend from the stem 402 for use by automated filling equipment. A bottom flange 410 may provide a snap fit with the housing 500.

In some embodiments, the additive reservoir may comprise a flexible pouch reservoir 420 configured to contain a volume of additive. The pouch reservoir 420 may be fastened in sealing engagement to the reservoir spout 400. In various embodiments, the pouch reservoir 420 may be fastened by heat welding or other fastening techniques to a fastening adapter portion 412 of the reservoir spout 400 to seal the pouch walls to the pouch reservoir spout 400. In FIGS. 3-4, the pouch reservoir 420 is depicted in a flat, unfilled state in FIGS. 3-4. As will be recognized, when filled with additive, the pouch reservoir 420 may assume another shape to fit within the housing 500.

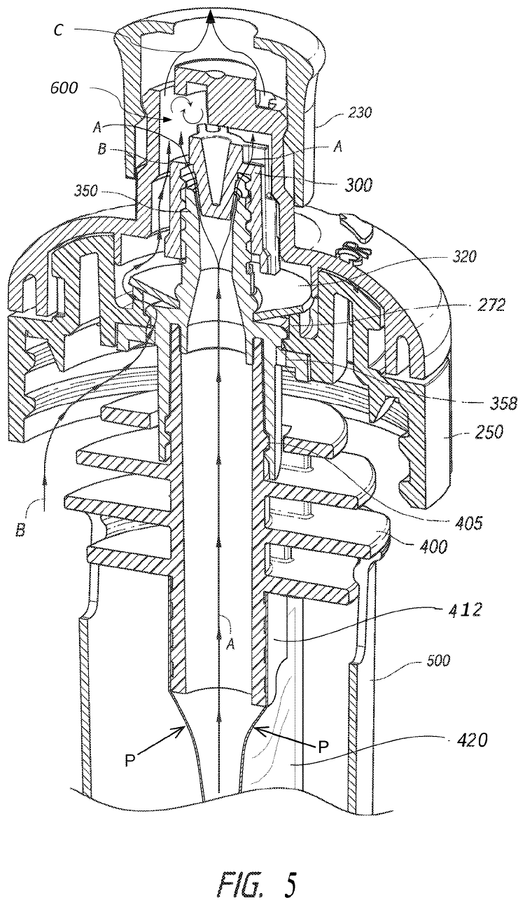

FIG. 5 illustrates a cutaway of one example of an assembled additive delivery system as an example of one additive delivery system which may be used in conjunction with beverage additives according to the present disclosure. In operation, a user may draw from, sip from, pour from, squeeze, or otherwise dispense from the system in such a way as to generate a change in pressure in a base fluid and/or a volume of air within a bottle or container (not shown) of the system. The base fluid may travel along a base fluid flow path B in response to the user dispensing fluid from the system. The base fluid flow path B may begin in a bottle 10 (see FIG. 1) or other vessel and/or in a space between the reservoir 420 and the housing 500, e.g., base fluid may flow into and out of openings of the housing 500, e.g., at the bottom of the housing 500 and/or near where the housing 500 engages with the spout 400. Flow from the vessel or housing 500 may, in some embodiments, travel through one or more base fluid ports 358 formed within the mixing nozzle 350. In some embodiments and as shown, the base fluid flow path B may further travel between an annular one-way base fluid flow seal 320 and an annular seat 272 of the cap base 250. It will be appreciated that although FIG. 5 depicts the annular one-way base fluid flow seal 320 in a closed position, a compliant nature of the seal 320 may permit the seal 320 to open to permit the base fluid to flow substantially as shown by the base fluid flow path B.

In some embodiments, the base fluid flow path B may then travel through an annular space defined between an interior surface of an additive adjustment actuator 200 (see FIG. 2) and the exteriors of both a mixing nozzle 350 and a metering insert 300. The base fluid flow path B may then travel into a mixing space 600 cooperatively defined in some embodiments by the metering insert 300, the mixing nozzle 350, and the additive adjustment actuator 200. In the mixing space 600, the base fluid traveling along the base fluid flow path B may converge and mix with an additive traveling along an additive flow path A, as will be described further below. The base fluid and the additive may mix to form a beverage mixture. The beverage mixture may exit the mixing space 600 along beverage mixture flow path C, which in some embodiments may travel from the mixing space 600 into the push-pull cap 230 and be dispensed via a dispensing outlet disposed on the push-pull cap 230.

Additionally in some embodiments, the user's dispensing from the system (e.g., drawing from, sipping, pouring, squeezing, etc.) may apply a pressure P to the additive reservoir or pouch reservoir 420. The pressure P may be applied via the base fluid (not shown) or a volume of air surrounding the pouch reservoir 420, which may undergo a change in pressure resulting from the user drawing, sipping, pouring, squeezing, or otherwise dispensing from the system. In response to the pressure P, the additive may be dispensed from the additive reservoir or pouch reservoir 420, and may flow along an additive flow path A. In some embodiments, the additive flow path A may travel through a metering space between a metering insert 300 and a mixing nozzle 350, as will be described further below, and may converge with the base fluid flow path B within the mixing space 600 to form a beverage mixture. The beverage mixture may be dispensed from the system via the dispensing outlet in the push-pull cap 230 along the beverage mixture flow path C as described above. In this regard, the mixing space 600 may fluidly couple both the additive reservoir (via the additive flow path A) and the base fluid container (via the additive flow path B) to the delivery system outlet.

In some embodiments, a metering space between the metering insert 300 and the mixing nozzle 350 may be adjustable. For example, in the embodiment shown, the additive flow adjustment actuator 200 (see FIG. 2) may be rotated relative to a cap base 250. Such rotation may additionally cause rotation of a metering insert 300 relative to the mixing nozzle 350. Cooperating threads between the metering insert 300 and mixing nozzle 350 may cause an axial movement of the insert 300 (in other words, the rotation of the metering insert 300 on the threads may cause the metering insert 300 to move upward or downward relative to the mixing nozzle 350 when viewed on the page, although it will be appreciated that the axis or direction of motion may be at any vertical or non-vertical orientation depending upon the orientation of the system at a given time). Axial movement of the metering insert 300 may change a spacing between the metering insert 300 and the mixing nozzle 350.

The space between the metering insert 300 and the mixing nozzle 350 may be referred to as the metering space. Changes in the metering space resulting from the axial movement of the metering insert 300 may cause corresponding changes in a flow of additive through the metering space along the additive flow path A. For example, in some embodiments, if the metering insert 300 is moved to be in contact with the mixing nozzle 350, the metering space may be closed to cut off the additive flow path A such that additive may no longer be dispensed from the additive reservoir or pouch reservoir 420.

Operation or performance of an additive delivery system (including a point-of-use system or a flow-through system as described herein) may be improved when used in conjunction with a beverage additive according to the present disclosure. In some embodiments, a viscosity of an additive may be selected to facilitate dispensing of the additive from an additive reservoir of an additive delivery system. For example, in some embodiments, the viscosity of the additive may be selected to facilitate dispensing of the additive from the pouch reservoir 420 in response to the pressure P. It will be appreciated that, in some embodiments, the viscosity may influence a responsiveness of the additive in the pouch reservoir 420 to the pressure P, for example by influencing a flow rate or a flow velocity of the additive out of the pouch reservoir 420 that may be generated by the pressure P. Accordingly, in one non-limiting example, a first additive having a lower viscosity may dispense more quickly (i.e., with a higher flow rate or a higher flow velocity) or may begin dispensing at a lower pressure P than a second additive having a higher viscosity.

In some embodiments, a viscosity of an additive may additionally or alternatively be selected to facilitate mixing of the additive with the base fluid within an additive delivery system or a flow-through system such as the one described above. For example, in some embodiments, the viscosity of the additive may be selected to facilitate mixing of the additive with the base fluid within the mixing space 600. It will be appreciated that, in some embodiments, the viscosity of the additive may influence a homogeneity of a beverage mixture mixed within the mixing space 600, for example by influencing a mixing rate of the additive with the base fluid. In one non-limiting example, a first additive having a lower viscosity may mix more quickly than a second additive having a higher viscosity. Accordingly, because the space or time available for mixing may be limited in some point-of-use or flow-through systems, the first additive may mix more thoroughly than the second additive within the given space or mixing time permitted within a particular mixing space 600.

In some embodiments, a viscosity of an additive may additionally or alternatively be selected to facilitate more precise metering of the additive within an additive delivery system such as the one described above. For example, in some embodiments, the viscosity of the additive may be selected to facilitate more precise metering of the additive through the metering space between the metering insert 300 and the mixing nozzle 350. It will be appreciated that, in some embodiments, the viscosity of the additive may influence a flow rate of the additive through a given metering space, and/or a minimum metering space required for the additive to flow therethrough. Accordingly, in one non-limiting example, a first additive having a lower viscosity may flow through a smaller minimum metering space or may have a flow rate through the metering space that may be more sensitive to changes in the metering space than a second additive having a higher viscosity.

Additionally or alternatively, in some embodiments, a density of an additive may be selected to facilitate dispensing of the additive from an additive reservoir of an additive delivery system. For example, in some embodiments, the density of the additive may be selected to facilitate dispensing of the additive from the pouch reservoir 420 in response to the pressure P. It will be appreciated that, in some embodiments, the density may influence a responsiveness of the additive in the pouch reservoir 420 to the pressure P, for example by influencing a flow rate or a flow velocity of the additive out of the pouch reservoir 420 that may be generated by the pressure P. Accordingly, in one non-limiting example, a first additive having a lower density may dispense more quickly (i.e., with a higher flow rate or a higher flow velocity) or may begin dispensing at a lower pressure P than a second additive having a higher density.

In some embodiments, a density of an additive may additionally or alternatively be selected to facilitate mixing of the additive with the base fluid within an additive delivery system such as the one described above. For example, in some embodiments, the density of the additive may be selected to facilitate mixing of the additive with the base fluid within the mixing space 600. It will be appreciated that, in some embodiments, the density of the additive may influence a homogeneity of a beverage mixture mixed within the mixing space 600, for example by influencing a mixing rate of the additive with the base fluid. In one non-limiting example, a first additive having a lower density may mix more quickly than a second additive having a higher density. Accordingly, although the space or time available for mixing may be limited in some point-of-use or flow-through systems, the first additive may mix more thoroughly than the second additive within the given space or mixing time permitted within a particular mixing space 600.

In some embodiments, a density of an additive may additionally or alternatively be selected to facilitate more precise metering of the additive within an additive delivery system such as the one described above. For example, in some embodiments, the density of the additive may be selected to facilitate more precise metering of the additive through the metering space between the metering insert 300 and the mixing nozzle 350. It will be appreciated that, in some embodiments, the density of the additive may influence a flow rate of the additive through a given metering space, and/or a minimum metering space required for the additive to flow therethrough. Accordingly, in one non-limiting example, a first additive having a lower density may flow through a smaller minimum metering space or may have a flow rate through the metering space that may be more sensitive to changes in the metering space than a second additive having a higher density.

Additionally or alternatively, in some embodiments, a specific gravity of an additive may be selected to facilitate dispensing of the additive from an additive reservoir of an additive delivery system. For example, in some embodiments, the specific gravity of the additive may be selected to facilitate dispensing of the additive from the pouch reservoir 420 in response to the pressure P. It will be appreciated that, in some embodiments, the specific gravity may influence a responsiveness of the additive in the pouch reservoir 420 to the pressure P, for example by influencing a flow rate or a flow velocity of the additive out of the pouch reservoir 420 that may be generated by the pressure P. Accordingly, in one non-limiting example, a first additive having a specific gravity closer to 1 (when the specific gravity is taken a ratio of the density of the additive to the density of the base fluid) may dispense more quickly (i.e., with a higher flow rate or a higher flow velocity) or may begin dispensing at a lower pressure P than a second additive having a specific gravity greater than 1.

In some embodiments, a specific gravity of an additive may additionally or alternatively be selected to facilitate mixing of the additive with the base fluid within an additive delivery system or a flow-through system such as the one described above. For example, in some embodiments, the specific gravity of the additive may be selected to facilitate mixing of the additive with the base fluid within the mixing space 600. It will be appreciated that, in some embodiments, the specific gravity of the additive may influence a homogeneity of a beverage mixture mixed within the mixing space 600, for example by influencing a mixing rate of the additive with the base fluid. In one non-limiting example, a first additive having a specific gravity closer to 1 (when the specific gravity is taken a ratio of the density of the additive to the density of the base fluid) may mix more quickly than a second additive having a specific gravity greater than 1. Accordingly, because the space or time available for mixing may be limited in some point-of-use or flow-through systems, the first additive may mix more thoroughly than the second additive within the given space or mixing time permitted within a particular mixing space 600.

In some embodiments, a specific gravity of an additive may additionally or alternatively be selected to facilitate more precise metering of the additive within an additive delivery system such as the one described above. For example, in some embodiments, the specific gravity of the additive may be selected to facilitate more precise metering of the additive through the metering space between the metering insert 300 and the mixing nozzle 350. It will be appreciated that, in some embodiments, the specific gravity of the additive may influence a flow rate of the additive through a given metering space, and/or a minimum metering space required for the additive to flow therethrough. Accordingly, in one non-limiting example, a first additive having a specific gravity closer to 1 (when the specific gravity is taken a ratio of the density of the additive to the density of the base fluid into which the additive may flow after flowing through the metering space) may flow through a smaller minimum metering space or may have a flow rate through the metering space that may be more sensitive to changes in the metering space than a second additive having a specific gravity greater than 1.

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. On the contrary, the present teachings encompass various alternatives, modifications, and equivalents, as will be appreciated by those of skill in the art. Accordingly, the foregoing description and drawings are by way of example only. More generally, those skilled in the art will readily appreciate that all parameters, dimensions, materials, and configurations described herein are meant to be exemplary and that the actual parameters, dimensions, materials, and/or configurations will depend upon the specific application or applications for which the teaching(s) of the present disclosure is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A beverage additive, comprising:
water at a proportion of about 40% to about 85% by weight of the additive;
an acidulant at a total proportion of about 1% to about 20% by weight of the additive, the acidulant comprising phosphoric acid at a proportion of about 0.1% to about 2% by weight of the additive; and
a flavor system at a proportion of about 10% to about 40% by weight of the additive.

2. The beverage additive of claim 1, wherein the acidulant comprises citric acid at a proportion of about 0.1% to about 10% by weight of the additive.

3. The beverage additive of claim 1, wherein the acidulant comprises lactic acid at a proportion of about 0.1% to about 10% by weight of the additive.

4. The beverage additive of claim 1, wherein the beverage additive has a viscosity and/or a specific gravity selected to facilitate rapid mixing of the beverage additive within a mixing space of a flow-through additive delivery system.

5. The beverage additive of claim 1, wherein the beverage additive has a kinematic viscosity between about 3 square millimeters per second (mm²/s) and about 7 mm²/s.

6. The beverage additive of claim 1, wherein the beverage additive has a specific gravity of about 0.9 to about 1.3.

7. The beverage additive of claim 1, wherein the flavor system comprises a sweetener.

8. The beverage additive of claim 7, wherein the sweetener comprises at least one of erythritol, sucralose, or a steviol glycoside.

9. The beverage additive of claim 1, further comprising a salt buffer at a proportion of about 0.5% to about 10% by weight of the additive.

10. The beverage additive of claim 9, wherein the salt buffer comprises at least one of sodium citrate or monopotassium phosphate.

11. The beverage additive of claim 1, wherein the beverage additive has a pH below about 3.3.

12. The beverage additive of claim 1, wherein the acidulant comprises:
citric acid at a proportion of about 6% to about 9% by weight of the additive,
lactic acid at a proportion of about 4% to about 7% by weight of the additive, and
phosphoric acid at a proportion of about 1.1% to about 1.4% by weight of the additive.

13. The beverage additive of claim 1, wherein the acidulant comprises:
citric acid at a proportion of about 3% to about 6.5% by weight of the additive,
lactic acid at a proportion of about 2% to about 4% by weight of the additive, and
phosphoric acid at a proportion of about 0.5% to about 1.3% by weight of the additive.

14. The beverage additive of claim 1, wherein the additive has a pH below about 3.3, and wherein the acidulant comprises:
citric acid at a proportion of about 0.7% to about 0.8% by weight of the additive,
lactic acid at a proportion of about 0.4% to about 0.5% by weight of the additive, and
phosphoric acid at a proportion of about 0.4% to about 0.5% by weight of the additive.

15. The beverage additive of claim 1, wherein the acidulant comprises about 6% to about 15% by weight of the additive and includes phosphoric acid at about 0.6% to about 1.3% by weight of the additive, citric acid at about 3.5% to about 8.5% by weight of the additive, and lactic acid at about 2% to about 8% by weight of the additive.

16. The beverage additive of claim 15, wherein the beverage additive has a kinematic viscosity between about 3 mm²/s and about 7 mm²/s, or a specific gravity of about 0.9 to about 1.3.

17. A beverage additive for use in an additive delivery system, the beverage additive comprising:
water at a proportion of about 40% to about 85% by weight of the additive;
an acidulant at a proportion of about 1% to about 20% by weight of the additive; and
a flavor system at a proportion of about 10% to about 40% by weight of the additive,
the beverage additive having a viscosity and/or a specific gravity selected to facilitate mixing of the beverage additive with a base fluid within a mixing space of the additive delivery system, the mixing space fluidly coupling both an additive reservoir and a base fluid container to a delivery system outlet, the additive delivery system configured to dispense the beverage additive from the additive reservoir and dispense the base fluid from the base fluid container into the mixing nozzle in response to a user drawing fluid through the delivery system outlet.

18. The beverage additive of claim 17, wherein the beverage additive has a kinematic viscosity between about 3 square millimeters per second (mm²/s) and about 7 mm²/s.

19. The beverage additive of claim 17, wherein the beverage additive has a specific gravity of about 0.9 to about 1.3.

20. The beverage additive of claim 17, wherein the flavor system comprises a sweetener.

21. The beverage additive of claim 20, wherein the sweetener comprises at least one of erythritol, sucralose, or a steviol glycoside.

22. The beverage additive of claim 17, further comprising a salt buffer at a proportion of about 0.5% to about 10% by weight of the additive.

23. The beverage additive of claim 22, wherein the salt buffer comprises at least one of sodium citrate or monopotassium phosphate.

24. The beverage additive of claim 17, wherein the acidulant comprises phosphoric acid at a proportion of about 0.1% to about 2% by weight of the additive.

25. The beverage additive of claim 24, wherein the proportion of phosphoric acid is selected to reduce a viscosity of the beverage additive by reducing the total proportion of the acidulant.

26. The beverage additive of claim 17, wherein the acidulant comprises citric acid at a proportion of about 0.1% by weight of the additive to about 10% by weight of the additive.

27. The beverage additive of claim 17, wherein the acidulant comprises lactic acid at a proportion of about 0.1% by weight of the additive to about 10% by weight of the additive.

28. The beverage additive of claim 17, wherein the beverage additive has a pH below about 3.3.

29. The beverage additive of claim 17, wherein the acidulant comprises:
citric acid at a proportion of about 6% to about 9% by weight of the additive,
lactic acid at a proportion of about 4% to about 7% by weight of the additive, and
phosphoric acid at a proportion of about 1.1% to about 1.4% by weight of the additive.

30. The beverage additive of claim 17, wherein the acidulant comprises:
citric acid at a proportion of about 3% to about 6.5% by weight of the additive,
lactic acid at a proportion of about 2% to about 4% by weight of the additive, and
phosphoric acid at a proportion of about 0.5% to about 1.3% by weight of the additive.

31. The beverage additive of claim 17, wherein the additive has a pH below about 3.3, and wherein the acidulant comprises:
citric acid at a proportion of about 0.7% to about 0.8% by weight of the additive,
lactic acid at a proportion of about 0.4% to about 0.5% by weight of the additive, and
phosphoric acid at a proportion of about 0.4% to about 0.5% by weight of the additive.

32-128. (canceled)
